(19) United States
(12) Patent Application Publication
(10) Pub. No.: US 2019/0039432 A1
(43) Pub. Date: Feb. 7, 2019

(54) STABILIZER ASSEMBLY FOR A VEHICLE

(71) Applicant: Ford Global Technologies LLC, Dearborn, MI (US)

(72) Inventor: Hank Xu, Nanjing (CN)

(21) Appl. No.: 16/031,761

(22) Filed: Jul. 10, 2018

(30) Foreign Application Priority Data
Aug. 4, 2017 (CN) 201710659877.5

(51) Int. Cl. B60G 21/055

(52) U.S. Cl. CPC B60G 21/0551; B60G 2206/427; B60G 2204/41; B60G 2204/15; B60G 2204/1222

(57) ABSTRACT

The present disclosure provides a stabilizer assembly for a vehicle. The stabilizer assembly includes a base panel and a stabilizer bar coupled with the base panel. The base panel includes a middle panel and two side panels spaced apart each other. The side panels extend from an inner edge of the middle panel by a first distance in a direction substantially perpendicular to a lateral direction of the middle panel. The stabilizer bar is coupled with the two side panels. A middle portion of the stabilizer bar between the two side panels and the inner edge of the middle panel define a second distance, and the second distance is greater than the first distance.

### RELATED APPLICATION

This application claims the benefit of Chinese Patent Application No. CN 201710659877.5, filed Aug. 4, 2017, the entire contents thereof being incorporated herein by reference.

### FIELD

The present disclosure relates to stabilizer devices, in particular, to a stabilizer assembly for improving lateral stiffness of a vehicle.

### BACKGROUND

A vehicle normally includes a chassis to support various parts of the vehicle. The chassis is configured to decrease vibrations during driving, and improve the stability of the vehicle. A front part of the chassis disposed at a front axle of the vehicle, also called a subframe, is used for supporting an engine of the vehicle. The subframe generally includes a stabilizer bar for enhancing the lateral stability. As a body of the subframe supports various different parts having complicated structures and the subframe has size limitation, a stabilizer bar is conventionally arranged at a position superimposed with the body of the subframe. For such subframe, the size of the body of the subframe should be large for mounting the stabilizer bar. In addition, the enforcement brackets disposed at two ends of the gap may not have desired supporting effects. There is a need for a lateral stabilizer assembly with a simple structure and sufficient lateral stability.

### SUMMARY

The present disclosure provides a stabilizer assembly which is easy in structure and simple to manufacture. Further, the stabilizer assembly has enhanced stiffness and lateral stability.

According to one aspect of the present disclosure, a stabilizer assembly for a vehicle is provided. The stabilizer assembly includes a base panel and a stabilizer bar coupled with the base panel. The base panel includes a middle panel and two side panels spaced apart each other and extending from an inner edge of the middle panel by a first distance in a direction substantially perpendicular to a lateral direction of the middle panel. The stabilizer bar is coupled with the two side panels. A middle portion of the stabilizer bar between the two side panels and the inner edge of the middle panel define a second distance, and the second distance is greater than the first distance.

In some embodiments, the stabilizer bar is coupled with the two side panels via two brackets, respectively.

In some embodiments, the stabilizer assembly further includes two bushings disposed between the stabilizer bar and the two brackets respectively, and each of the bushings surrounds at least a portion of the stabilizer bar.

In some embodiments, the bushings are rubber parts coupled on the brackets via vulcanization.

In some embodiments, the stabilizer assembly further includes two bearings fixed on the side panels, respectively, and each of the bearings is disposed between the stabilizer bar and one of the bushings.

In some embodiments, the stabilizer assembly further includes two flanges fixed on the stabilizer bar and adjacent to the two brackets.

In some embodiments, the two flanges contact with two bushings, respectively, to prevent lateral movement of the stabilizer bar.

In some embodiments, each of the side panels includes a first surface coplanar with an upper surface of the middle panel, and each of the brackets includes a first end portion, a second end portion opposite to the first end, and a middle portion between the first and second ends.

In some embodiments, both the first and second end portions of each of the brackets are connected on the first surface of the side panel.

In some embodiments, each of the side panels includes a second surface extending from the first surface and a connection portion extending from the second surface. The second surface is between the first surface and the connection portion and forms a first angle with the first surface, the connection portion forms a second angle with the second surface. The first and second end portions of each of the brackets are connected with the first surface and the connection portion, respectively.

According to a second aspect of the present disclosure, a stabilizer assembly for a vehicle is provided. The stabilizer assembly includes a base panel disposed below an engine of the vehicle, a first bracket and a second bracket coupled with the base panel, and a stabilizer bar coupled with the base panel via the first and second brackets. The base panel includes a middle panel, a first side panel, and a second side panel spaced apart from the first side panel. The first and second panels extend from an inner edge of the middle panel by a first distance in a direction substantially perpendicular to the inner edge of the middle panel. The middle panel, and the first and second side panel define a gap area corresponding to a position of the engine. The first and second brackets are coupled with the first and second side panels respectively. The stabilizer bar is rotatable about a central axis of the stabilizer bar to deliver lateral loads between the first and second side panels. The stabilizer bar includes a middle portion between the first and second side panels. The middle portion is positioned substantially along a line that passes through distal ends of the first and second side panels or offset from the line toward a front of the vehicle.

In some embodiments, a central axis of the middle portion is below or coplanar to an upper surface of the middle panel.

In some embodiments, the base panel is a part of a chassis of the vehicle, and the base panel is coupled to a body of the vehicle at positions spaced away from the first and second end panels.

In some embodiments, the stabilizer bar includes two side bars connected with two ends of the middle portion, the two side bars are connected with shock absorbers of the vehicle via linkages, respectively.

In some embodiments, the stabilizer bar includes two side bars connected at two ends of the middle portion and disposed outside the first and second brackets, respectively. The middle portion includes a body and two transition portions extending from two ends of the body to the side bars, respectively.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

The above advantages and other advantages, and features of the present description will be readily apparent from the following detailed description when taken alone or in connection with the accompanying drawings.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view of a stabilizer assembly for a vehicle according to an embodiment of the present disclosure.

FIG. 2 is a top view of the stabilizer assembly in FIG. 1.

FIG. 3 is a front view of the stabilizer assembly in FIG. 1.

FIG. 4 is an enlarged view of the partial stabilizer assembly in FIG. 1.

FIG. 5 is a perspective view of a stabilizer assembly for a vehicle according to another embodiment of the present disclosure.

FIG. 6 is a top view of a part of a vehicle according to an embodiment of the present disclosure, illustrating a front axle of the vehicle.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed stabilizer assemblies will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various stabilizer assemblies are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

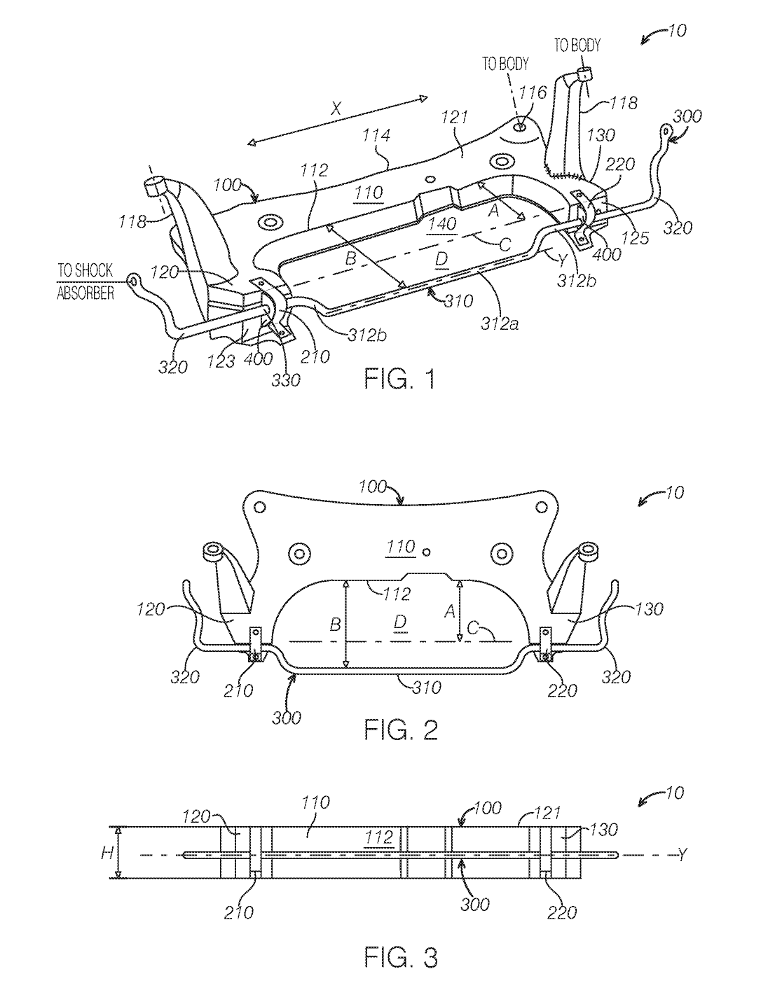

Referring to FIG. 1, a stabilizer assembly 10 for a vehicle is illustrated. The stabilizer assembly 10 includes a base panel 100 and a stabilizer bar 300 coupled to a side of the base panel 100 for improving the stiffness and/or stability of the base panel 100. The base panel 100 may be made from metal or partially made from metal, such as steel. The stabilizer bar 300 may be formed with metal such as steel, and may be formed as a solid bar or a hollow bar.

The base panel 100 includes a middle panel 110 and two side panels extending from an edge of the middle panel 110 by a determined distance, such as a first side panel 120 and a second side panel 130. The base panel 100 may be a part of a chassis for supporting a body of the vehicle, and connected with the body of the vehicle at positions away from the first or second side panels 120, 130. Referring to FIG. 1, the middle panel 110 has two edges in a lateral direction X, e.g., a first edge or an inner edge 112 and a second edge 114 opposite to the first edge 112. The first edge or the inner edge 112 is closer to the stabilizer bar 300 than the second edge 114. Fasteners may be disposed at two ends of the edge 114 to connect the stabilizer assembly 10 with the body (not shown) of the vehicle. In an embodiment, two through holes 116 are formed at two ends of the second edge 114, and two fasteners such as bolts (not shown) may pass the through holes 116 and be inserted in the body of the vehicle to connect the stabilizer assembly 10 with the body. In some embodiments, the second edge 114 may have an arc shape projecting towards the first edge 112 such that the middle panel 110 can be formed with less material and have less manufacturing cost.

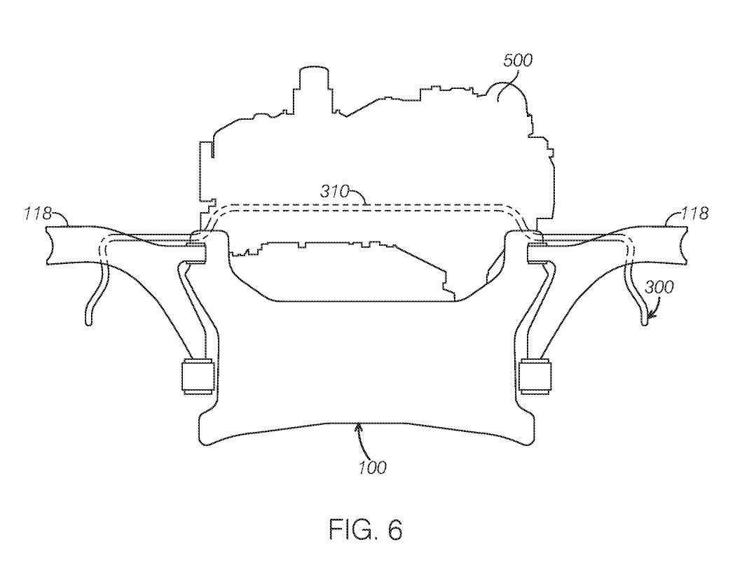

The first side panel 120 and the second side panel 130 may extend from the first edge 112 of the middle panel 110 in a direction substantially perpendicular to the lateral direction X. The first and second side panels 120, 130 are spaced apart and extending from the first edge 112 by a substantially same distance, i.e., a first distance A. It will be appreciated that the first distance A may be a distance between a line C and the first edge 112 of the middle panel 110. The line C connects ends 123, 125 of the first and second side panels 120, 130 which are spaced away from the middle panel 110. Referring to FIGS. 1-2 and 6, the first side panel 120, the second side panel 130, and the first edge 112 of the middle panel 110 define a gap area D corresponding to the position of an engine 500 of the vehicle. Referring to FIG. 6, the engine 500 may be disposed above the stabilizer assembly 10, and at least a part of the engine 500 corresponds to the gap area D. The stabilizer assembly 10 supports the engine 500 and moves with the engine 500 to reduce impacts to passengers.

In some embodiments, as shown in FIG. 1, a connection arm 118 is disposed at an edge of the base panel 100 that is perpendicular to the lateral direction X. The connection arm 118 extends outwards and upwards for connecting the base panel 100 to other parts of the vehicle. In some embodiments, a reinforcement bracket (not shown) may be coupled at areas adjacent to the connection arm 118 in the first side panel 120 or the second side panel 130, such that lateral stiffness of the stabilizer assembly 10 may be improved.

Referring to FIGS. 1 and 2, the stabilizer bar 300 is disposed adjacent to the first edge 112 of the middle panel 110, and coupled to the middle panel 110 via a first bracket 210 disposed on the first side panel 120 and a second bracket 220 disposed on the second side panel 130. The stabilizer bar 300 includes a middle portion 310 between the first bracket 210 and the second bracket 220, and two side bars 320 coupled at two ends of the middle portion 310. The stabilizer bar 300 may be substantially U-shaped. Each of the side bars 320 extends outwards along the lateral direction X and then bent toward the second edge 114 of the middle panel 110. Each of the side bars 320 is coupled to a shock absorber of the vehicle via a linkage such that the side bars 320 may move up and down. The middle portion 310 extends substantially parallel to the lateral direction X, and defines a second distance B between the first edge or the inner edge 112 of the middle panel 110 and the middle portion 310 at a direction substantially perpendicular to the lateral direction X. In some embodiments, as shown in FIGS. 1-2, the second distance B is greater than the first distance A. As describe above, the first distance A is the distance between the line C connecting two ends 123, 125 of the first or second side panel 120, 130 and the inner edge 112.

The stabilizer bar 300 may improve the lateral stiffness of the base panel 100. The middle portion 310 is arranged away from the middle panel 110 of the base panel 100. That is, the projection of the middle portion 310 in a vertical direction or a direction perpendicular to an upper surface 121 of the middle panel 110 is spaced apart from the first edge 112 of the middle panel 110 with the second distance B. In this way, the middle panel 110 may be formed with a smaller size and less materials, which reduces the total weight and manufacturing cost of the vehicle.

In addition, the stabilizer bar 300 is coupled to the first side panel 120 and the second side panel 130 without direct connection with the middle panel 110, and thus there is no need for placing fasteners on the middle panel 110 for fixing the stabilizer bar 300. In this way, more room is provided on the middle panel 110 for connecting with other parts of the vehicle, such as a torque converter, a steering device, and a transmission. Referring to FIG. 5, the middle portion 310 of the stabilizer bar 300 is positioned on a load path P. As the load path P is in an optimal area for improving the stiffness of the middle panel 110, the stabilizer bar 300 improves the stiffness of the base panel 100 and additional brackets for reinforcement on the first side panel 120 or the second side panel 130 may not be needed.

In some embodiments, the middle portion 310 of the stabilizer bar 300 includes a body 312a extending substantially parallel to the lateral direction X and two transition portions 312b bending outwards from two ends of the body 312a to the side bars 320. The transition portions 312b and the side bars 320 may form as vertical edges of the U-shaped stabilizer bar 300. When the body of the vehicle is tilted, the stabilizer bar 300 may twist against the tilting and provide lateral stability for the vehicle. In addition, the curved transition portions 312b increases a total length of the stabilizer bar 300 between the first bracket 210 and the second bracket 220, thus reducing a tension applied on the stabilizer bar 30X). In this way, the stabilizer bar 300 may be constructed with a smaller diameter.

In some embodiments, the stabilizer bar 300 may be coupled to the first side panel 120 and the second side panel 130 via the first bracket 210 and the second bracket 220 respectively. Two ends of the middle portion 310, may be received in the first bracket 210 and the second bracket 220, respectively, which restricts the movements of the stabilizer bar 300 in an up-down direction. During driving of the vehicle, lateral loads of the vehicle may be delivered from the first side panel 120 to the second side panel 130 via the middle portion 310 of the stabilizer bar 300, and vice versa.

In some embodiments, a bushing 400 is provided between the middle portion 310 of the stabilizer bar 300 and the first bracket 210 or the second bracket 220. Referring to FIG. 1, the bushing 400 may be positioned over the end of the middle portion 310. The bushing 400 includes a first portion contacting with the first bracket 210 or the second bracket 220 and a second portion contacting with the first side panel 120 or the second side panel 130. In some embodiments, the bushing 400 may be fixed on the first side panel 120 or the second side panel 130, and/or the first bracket 210 or the second bracket 220. The stabilizer bar 300 passes through an opening in the bushing 400 and may rotate relative to the bushing 400. During driving of the vehicle, the side bars 320 of the stabilizer bar 300 may move upwards and downwards with the shock absorbers, the the middle portion 310 may rotate about its central axis Y (substantially parallel with the direction X) with movements of the side bars 320.

In some embodiments, the bushing 400 may be formed with flexible materials, such as rubber. The bushing 400 is used to reduce friction between the stabilizer bar 300 and the base panel 100 or the first or second brackets 210, 220, such that the usage life of the stabilizer assembly 10 may be increased. In addition, the bushing 400 may buffer movements of the stabilizer bar 300 relative to the base panel 100, thus reducing the noise vibration harshness (NVH) of the vehicle. In some embodiments, the bushing 400 may be rubber parts connected to the first bracket 210 or the second bracket 220 via vulcanization. In this way, the bushing 400 and the first bracket 210 or the second bracket 220 may be formed integrally, thus the manufacturing process may be simplified and the cost can be reduced.

In some embodiments, as shown in FIG. 5, a bearing 217 is disposed between the stabilizer bar 300 and the first bracket 210 or the second bracket 220. The bearing 217 may be fixed on the first side panel 120 or the second side panel 130, sleeved over two ends of the middle portion 310 of the stabilizer bar 300 and contact the bushing 400. In an embodiment, the bearing 217 includes an outer ring fixed on the first bracket 210 or the second bracket 220 and an inner ring fixed on the middle portion 310. The inner ring is rotatable relative to the outer ring, such that the middle portion 310 may be rotatable about its centeral axis Y with movements of the inner ring.

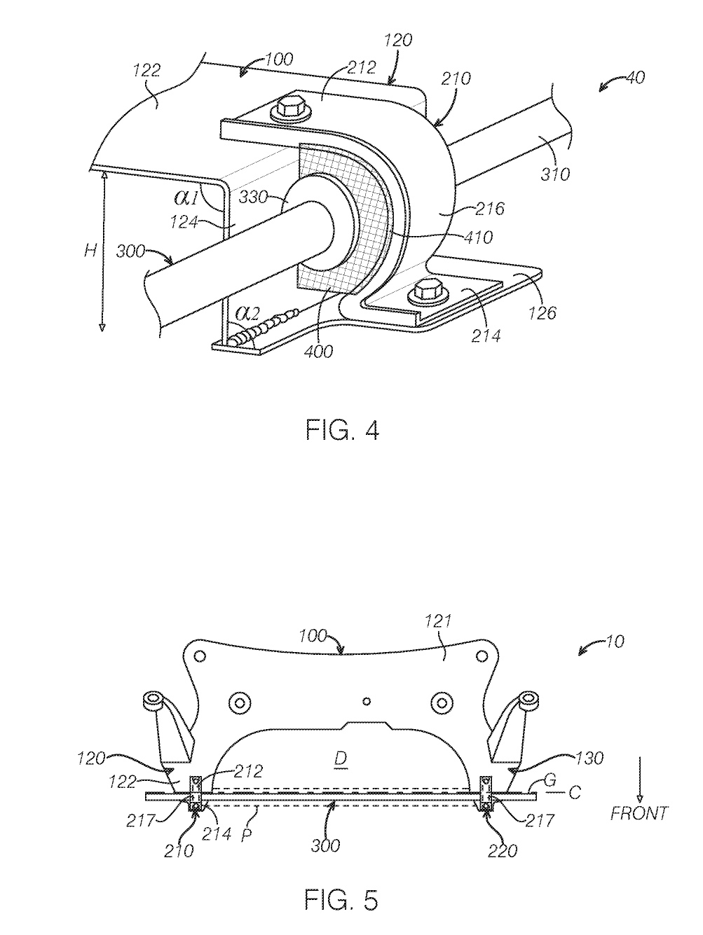

FIG. 4 is an enlarged view of a portion of the stabilizer assembly 10 in FIG. 1, illustrating the first side panel 120, the first bracket 210, and a portion of the stabilizer bar 300. With reference to FIGS. 1 and 4, a flange 330 is disposed on the stabilizer bar 300 at a position adjacent to the first bracket 210. The flange 330 may be connected to an end of the middle portion 310 via welding, and contact the bushing 400 or the first or second bracket 210, 220. The flange 330 may have a circular cross-section and be fixed on the stabilizer bar 300 (i.e., unmovable relative to the stabilizer bar 300) to deliver lateral loads.

Referring to FIG. 4, the flange 330 has an outer diameter smaller than an outer diameter or perimeter of the bushing 400, and disposed on the end of the middle portion 310 and at an external side of the first bracket 210. The other end of the middle portion 310 adjacent to the second bracket 220 may be provided with a second flange (not shown). Similarly, the second flange has an outer diameter smaller than the outer diameter of the bushing 400, and disposed at an external side of the second bracket 220. The flange 330 contacts with the bushing 400 in the first bracket 210 to prevent movements of the stabilizer bar 300 in the lateral direction X. In this way, movements of the stabilizer bar 300 along its central axis Y may be prevented, which facilitates the delivery of the loads between the first side panel 120 and the second side panel 130.

It should be appreciated that “external side of the first bracket 210” refers to a side of the first bracket 210 distal from the middle portion 310, and “internal side of the first bracket 210” refers to a side of the first bracket 210 adjacent to the middle portion 310. For example, as shown in FIGS. 1 and 4, the external and internal side of the first bracket 210 may refer to left and right sides of the first bracket 210, respectively, and the external and internal side of the second bracket 220 may refer to right and left sides of the second bracket 220, respectively.

In some embodiments, two flanges may be disposed at two ends of the middle portion 310 of the stabilizer bar 300 and adjacent to the internal sides of the first bracket 210 and the second bracket 220 respectively (not shown).

In some embodiments, the flange 330 may have an outer diameter larger than the outer diameter of the bushing 400 or even larger than the outer diameter of the first or second brackets 210, 220 (not shown).

In some embodiments, as shown in FIG. 4, the bushing 400 further includes an extension portion 410 extending outwards radially and covering a portion of the first bracket 210. During vibration of the vehicle, the flange 330 always contact with the extension portion 410 of the bushing 400, which may reduce the wearing of the flange 330 due to contacts between the rigid flange 330 and the brackets and decrease NVH of the vehicle.

With reference to FIGS. 1 and 4, the first panel 120 or the second side panel 130 may each have a stepped shape. The first side panel 120 has a first surface 122 coplanar with an upper surface 121 of the middle panel 110, a second surface 124 connected to the first surface 122 and forming a first angle α1 with the first surface 122, and a connection portion 126 extending outwards from the second surface 124 and forming a second angle α2 with the second surface 124. In some embodiments, as shown in FIG. 4, the first surface 122 is coplanar with the upper surface 121 of the middle panel 110. The second surface 124 extends downwards from the first surface 122 by a predetermined distance. The connection portion 126 may be a plate protruded from the second surface 124, which extends from a bottom edge of the second surface 124 in a direction substantially perpendicular to the second surface 124.

In some embodiments, as shown in FIGS. 1 and 4, the first bracket 210 includes a first end portion 212, a second end portion 214 opposite to the first end 212, and a middle section 216 between the first and second end portions 212, 214 and configured to receive the middle portion 310 of the stabilizer bar 300. The bushing 400 is sleeved over the stabilizer bar 300 and contacts with the middle section 216 of the first bracket 210. As shown in FIG. 4, the first end portion 212 may be fixed on the first surface 122 of the first side panel 120 via a fastener, and the second end portion 214 may be fixed on the connection portion 126 via a fastener. The fastener may be a bolt, which passes through holes in the first end portion 212 or the second end portion 214 to be inserted in the first surface 122 or the connection portion 126, thus fixing the first bracket 210 on the first side panel 120. It will be appreciated that the first end portion 212 or the second end portion 214 may be connected on the first side panel 120 via other approaches, such as welding.

Referring to FIG. 2, the middle portion 310 of the stabilizer bar 300 may be biased away or offset from a line C towards a front of the vehicle, i.e. in a direction away from the first edge 112, and the line C is a line passing through the distant ends 123, 125 of the first side panel 120 and the second side panel 130. In some embodiments, referring to FIG. 3, the central axis Y of the middle portion 310 of the stabilizer bar 300 may be disposed not higher than the upper surface 121 of the middle panel 110. In some embodiments, the central axis Y of the middle portion 310 may be located within a height range H of the first side panel 120 or the second side panel 130. The middle portion 310 and two side bars 320 of the stabilizer bar 300 may be located in a same plane.

Alternatively, in embodiments as shown in FIG. 5, a surface G of the middle portion 310 of the stabilizer bar 300 may be positioned along the line C that passes through the distal ends 123, 125 of the first side panel 120 and the second side panel 130. In some embodiments, the middle portion 310 may be a straight bar, and the middle portion 310 and two side bars 320 are located in a same plane. In some embodiments, the middle portion 310 of the stabilizer bar 300 includes a body 312a and two transition parts 312b bending from two ends of the body towards the first edge 122 of the middle panel 110 to be connected to the side bars 320. The plane defined by the body 312a and the transition parts 312b and the plane defined by the side bars 320 may form an angle therebetween.

It will be appreciated that connections between the first bracket 210 and the first side panel 120 are not limited to embodiments as shown in FIGS. 1 and 4. In some embodiments, the first and second end portions 212, 214 of the first bracket 210 may be connected to other surfaces of the first side panel 120. With reference to FIG. 5, both the first and second end portions 212, 214 of the first bracket 210 are connected on the first surface 122 of the first panel side 120 that is coplanar with the upper surface 121 of the middle panel 110. The middle portion 310 of stabilizer bar 300 is substantially located along the line C. In this embodiments, the central axis Y of the stabilizer bar 300 may be positioned higher than an upper surface 121 of the middle panel 110.

In some embodiments, the first and second end portions 212, 214 of the first bracket 210 may be both connected on the second surface 124 of the first side panel 120 (not shown). In such embodiments, the second surface may have a relatively larger height to form sufficient support for the first bracket 210.

It will be appreciated that, the second side panel 130, the second bracket 220, and the connection therebetween are the same or similar to the first side panel 120, the first bracket 210, and the connection therebetween as described above, and will not be described in detail.

The stabilizer assembly according to embodiments of the present disclosure is simple in structure and easy to manufacture. Further, the lateral stability or stiffness of the vehicle may be improved, and thus transient operation of the vehicle may be enhanced.

The stabilizer assembly of the present disclosure may be used in a passenger vehicle, a commercial vehicle, or various other vehicles, such as agriculture machines, transportation ships, or airplanes. Those applications should be considered as included in the scope of term “vehicle” cited in this disclosure.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A stabilizer assembly for a vehicle, comprising:
a base panel including a middle panel and two side panels spaced apart each other, wherein the side panels extends from an inner edge of the middle panel by a first distance in a direction substantially perpendicular to a lateral direction of the middle panel; and
a stabilizer bar coupled with the two side panels, wherein a middle portion of the stabilizer bar between the two side panels and the inner edge of the middle panel define a second distance, and the second distance is greater than the first distance.

2. The stabilizer assembly of claim 1, wherein the stabilizer bar is coupled with the two side panels via two brackets, respectively.

3. The stabilizer assembly of claim 2, further comprising two bushings disposed between the stabilizer bar and the two brackets respectively, and each of the bushings surrounds at least a portion of the stabilizer bar.

4. The stabilizer assembly of claim 3, wherein the bushings are rubber parts coupled on the brackets via vulcanization.

5. The stabilizer assembly of claim 4, further comprising two bearings fixed on the side panels, respectively, and each of the bearings is disposed between the stabilizer bar and one of the bushings.

6. The stabilizer assembly of claim 5, further comprising: two flanges fixed on the stabilizer bar and adjacent to the two brackets.

7. The stabilizer assembly of claim 6, wherein the two flanges contact with two bushings, respectively, to prevent lateral movement of the stabilizer bar.

8. The stabilizer assembly of claim 2, wherein each of the side panels includes a first surface coplanar with an upper surface of the middle panel, and each of the brackets includes a first end portion, a second end portion opposite to the first end, and a middle portion between the first and second ends.

9. The stabilizer assembly of claim 8, wherein both the first and second end portions of each of the brackets are connected on the first surface of the side panel.

10. The stabilizer assembly of claim 7, wherein each of the side panels includes a second surface extending from the first surface and a connection portion extending from the second surface, the second surface is between the first surface and the connection portion and forms a first angle with the first surface, the connection portion forms a second angle with the second surface, and wherein the first and second end portions of each of the brackets are connected with the first surface and the connection portion, respectively.

11. A stabilizer assembly for a vehicle, comprising:
a base panel disposed below an engine of the vehicle, wherein the base panel includes a middle panel, a first side panel, and a second side panel spaced apart from the first side panel, the first and second panels extend from an inner edge of the middle panel by a first distance in a direction substantially perpendicular to the inner edge of the middle panel, and wherein the middle panel, and the first and second side panel define a gap area corresponding to a position of the engine;
a first bracket and a second bracket coupled with the first and second side panels respectively; and
a stabilizer bar coupled with the base panel via the first and second brackets and rotatable about a central axis of the stabilizer bar to deliver lateral loads between the first and second side panels, wherein the stabilizer bar includes a middle portion between the first and second side panels, and wherein the middle portion is positioned substantially along a line that passes through distal ends of the first and second side panels or offset from the line toward a front of the vehicle.

12. The stabilizer assembly of claim 11, wherein a central axis of the middle portion is below or coplanar to an upper surface of the middle panel.

13. The stabilizer assembly of claim 11, wherein the base panel is a part of a chassis of the vehicle, and the base panel is coupled to a body of the vehicle at positions spaced away from the first and second end panels.

14. The stabilizer assembly of claim 11, wherein the stabilizer bar includes two side bars connected with two ends of the middle portion, the two side bars are connected with shock absorbers of the vehicle via linkages, respectively.

15. The stabilizer assembly of claim 11, wherein the stabilizer bar includes two side bars connected at two ends of the middle portion and disposed outside the first and second brackets, respectively, and the middle portion includes a body and two transition portions extending from two ends of the body to the side bars, respectively.
